(19) United States
(12) Patent Application Publication
(10) Pub. No.: US 2005/0020437 A1
(43) Pub. Date: Jan. 27, 2005

(54) Microparticulate material

(76) Inventors: Holger Winkler, Darmstadt (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/497,853

(22) PCT Filed: Oct. 31, 2002
(86) PCT No.: PCT/EP02/12201

(30) Foreign Application Priority Data
Dec. 7, 2001 (DE) 101 60 328.2

(51) Int. Cl. B01J 31/00; C08F 4/44

(52) U.S. Cl. 502/118; 502/159; 502/102; 502/103; 502/108; 526/160; 526/943; 526/901

(57) ABSTRACT

The present invention relates to microparticulate materials comprising nanoparticulate cores of inorganic material with oligomeric or polymeric structures containing non-acidic, nucleophilic groups on their surface, where the cores have been agglomerated via an interaction of the non-acidic, nucleophilic groups with at least one further constituent containing electrophilic groups. The present invention furthermore relates to catalysts built up from these materials, to processes for the production of these materials or catalysts, to the use of the catalysts for the polymerisation of olefins, and to a polymerisation process using the catalysts.

The present invention relates to micro- and nanoparticulate materials, to catalysts built up from these materials, to processes for the production of these materials or catalysts, to the use of the catalysts for the polymerisation of olefins, and to a polymerisation process using the catalysts.

Metallocene-catalysed polymerisation has experienced an enormous upswing since the beginning of the 1980s. Initially conceived as a model system for Ziegler-Nafta catalysis, it has increasingly developed into an independent process with enormous potential for the (co)polymerisation of ethene and higher 1-olefins. Besides the activity-increasing use of the cocatalyst methylaluminoxane instead of simple trialkyl compounds, the crucial factor for the rapid development is the constant improvement in the activity and stereoselectivity due to systematic catalyst structure/activity relationships (G. G. Hlatky, Coord. Chem. Rev. 1999, 181, 243; R. Mülhaupt, Nachr. Chem. Tech. Lab. 1993, 41, 1341).

However, homogeneous catalysts are of only limited suitability for large-scale industrial use in the gas or suspension polymerisation processes usually used. Agglomeration of the catalytically active centres frequently occurs, with the consequence of caking on the reactor walls, etc., known as “reactor fouling”. As a consequence, supported catalysts were therefore developed. The catalyst support is intended to avoid the said problems.

The support substances usually described here are based on inorganic compounds, such as silicon oxides (for example U.S. Pat. No. 4,808,561, U.S. Pat No. 5,939,347, WO 96/34898) or aluminium oxides (for example M. Kaminaka, K. Soga, Macromol. Rapid Commun. 1991, 12, 367) or phyllosilicates (for example U.S. Pat. No. 5,830,820; DE-A-197 27 257; EP-A-849 288), zeolites (for example L. K. Van Looveren, D. E. De Vos, K. A. Vercruysse, D. F. Geysen, B. Janssen, P. A. Jacobs, Cat. Lett. 1998, 56(1), 53) or on model systems, such as cyclodextrins (D. -H. Lee, K. -B. Yoon, Macromol. Rapid Commun. 1994, 15, 841; D. Lee, K. Yoon, Macromol. Symp. 1995, 97, 185) or polysiloxane derivatives (K. Soga, T. Arai, B. T. Hoang, T. Uozumi, Macromol. Rapid Commun. 1995, 16, 905).

A fresh problem which occurs on use of supports is the associated reduction in the activity and selectivity of the catalyst compared with homogeneous polymerisation.

Accordingly, there was a demand for materials which avoid the disadvantages of the prior art on use in heterogeneous catalysts.

Surprisingly, it has now been found that the agglomerates of nanoparticles having an inorganic core which are described below can advantageously be employed for catalysts of this type.

The present invention relates firstly to a microparticulate material comprising nanoparticulate cores of inorganic material with oligomeric or polymeric structures containing non-acidic, nucleophilic groups on their surface, where the cores have been agglomerated via interaction of the non-acidic, nucleophilic groups with at least one further constituent containing electrophilic groups.

The microparticulate material is preferably a catalyst formed from a support, at least one catalytically active species and optionally at least one cocatalyst, which is characterised in that the support comprises cores of inorganic material with oligomeric or polymeric structures containing non-acidic, nucleophilic groups on their surface, and the cores have been agglomerated via interaction of the non-acidic, nucleophilic groups with at least one further constituent containing electrophilic groups.

The term “nanoparticulate” is applied here to all particles whose average mean particle diameter is in the range from about 1 nm to less than 1000 nm. Correspondingly, the term “microparticulate” is applied to all particles whose average mean particle diameter is in the range from 1 μm to less than 1000 μm.

The further constituents containing electrophilic groups are preferably at least one catalytically active species or at least one cocatalyst.

The present invention furthermore relates to a nanoparticulate material comprising cores of inorganic material, where oligomeric or polymeric structures containing non-acidic, nucleophilic groups are present on the surface of the cores.

The core of an inorganic material preferably consists of a metal or semimetal or a metal salt, but particularly preferably a metal chalcogenide or metal pnictide. For the purposes of the present invention, the term “chalcogenides” is applied to compounds in which an element from group 16 of the Periodic Table is the electronegative binding partner; the term “pnictides” is applied to those in which an element from group 15 of the Periodic Table is the electronegative binding partner.

Preferred cores consist of metal chalcogenides, preferably metal oxides, or metal pnictides, preferably nitrides or phosphides. For the purposes of these terms, “metals” are all elements which can occur as electropositive partner compared with the counterions, such as the classical sub-group metals or the main-group metals from the first and second main groups, but also all elements from the third main group as well as silicon, germanium, tin, lead, phosphorus, arsenic, antimony and bismuth. The preferred metal chalcogenides and metal pnictides include, in particular, silicon dioxide, zirconium dioxide, titanium dioxide, aluminium oxide, gallium nitride, boron nitride, aluminium nitride, silicon nitride and phosphorus nitride.

For the purposes of the invention, particular preference is given to microparticulate or nanoparticulate materials which are characterised in that the inorganic material of the cores is an oxidic material which is preferably selected from the oxides of the elements from main groups 3 and 4 and sub-groups 3 to 8 of the Periodic Table, particularly preferably an aluminium oxide, silicon oxide, boron oxide, germanium oxide, titanium oxide, zirconium oxide or iron oxide, or a mixed oxide or an oxide mixture of the said compounds.

In a variant of the present invention, the starting material employed for the production of the core/shell particles according to the invention preferably comprises monodisperse cores of silicon dioxide, which can be obtained, for example, by the process described in U.S. Pat. No. 4,911,903. The cores here are produced by hydrolytic polycondensation of tetraalkoxysilanes in an aqueous ammoniacal medium, in which firstly a sol of primary particles is produced, and the resultant SiO₂ particles are subsequently converted to the desired particle size by continuous, controlled metered addition of tetraalkoxysilane. This process enables the production of monodisperse SiO₂ cores having a standard deviation of the mean particle diameter of 5%.

A further preferred starting material comprises SiO₂ cores which have been coated with (semi)metals or non-absorbent metal oxides, such as, for example, TiO₂, ZrO₂, ZnO₂, SnO₂ or Al₂O₃. The production of metal oxide-coated SiO₂ cores is described in greater detail, for example, in U.S. Pat. No. 5,846,310, DE 198 42 134 and DE 199 29 109.

A further starting material which can be employed comprises monodisperse cores of metal oxides, such as TiO₂, ZrO₂, ZnO₂, SnO₂ or Al₂O₃, or metal-oxide mixtures. Their production is described, for example, in EP 0,644,914. Furthermore, the process of EP 0,216,278 for the production of monodisperse SiO₂ cores can readily be applied with the same result to other oxides. Tetraethoxysilane, tetrabutoxytitanium, tetrapropoxyzirconium or mixtures thereof are added in one portion with vigorous mixing to a mixture of alcohol, water and ammonia whose temperature has been set accurately to from 30 to 40° C. using a thermostat, and the resultant mixture is stirred vigorously for a further 20 seconds, giving a suspension of monodisperse cores in the nanometer range. After a post-reaction time of from 1 to 2 hours, the cores are separated off in a conventional manner, for example by centrifugation, washed and dried.

The oligomeric or polymeric structures containing non-acidic, nucleophilic groups on the surface of the cores are preferably polymers (where the term “oligomers” below is basically included under the term polymer) which have been grafted or polymerised onto the surface, i.e. have been synthesised on the surface. The polymers may be branched or unbranched; in a preferred embodiment, the polymers have a linear structure. The non-acidic, nucleophilic groups here may be present directly in the main chain or can be in the form of functional groups or small molecules as a side chain. The polymers may either have been grafted or polymerised directly onto the optionally functionalised surface, i.e. synthesised on the surface, or bonded to the surface via a spacer. In a preferred embodiment of the invention, the spacer is an inert polymer, such as polyethylene, polypropylene or polystyrene, or a cyclic or acyclic low-molecular-weight hydrocarbon compound, particularly preferably an alkyl chain having 1-20 carbon atoms. The polymer containing non-acidic, nucleophilic groups is preferably a polyether, such as, in particular, polyethylene oxide, polypropylene oxide or a mixed polymer of ethylene oxide and propylene oxide, or polyvinyl alcohol, a polysaccharide or a polycyclodextrin.

In accordance with the invention, these oligomeric or polymeric structures are applied to the inorganic cores after the latter have been formed. The present invention therefore furthermore relates to a process for the production of a nanoparticulate material which is characterised in that oligomeric or polymeric structures containing non-acidic, nucleophilic groups are applied to the surface of cores of inorganic material.

In order to apply the oligomeric or polymeric structures to the surface of the cores, it may be advantageous, as already stated above, for the surface of the cores to be functionalised. A process in which the surface of the cores is functionalised before application of the oligomeric or polymeric structures is therefore preferred for the purposes of the invention. It may be particularly preferred here to apply to the surface chemical functions which, as active chain end, enable the shell polymers to be grafted on. Examples which may be mentioned here are, in particular, terminal double bonds, halogen functions, epoxy groups and polycondensable groups. The functionalisation here can take place directly during production of the particles. In a preferred embodiment, functionalised silicon dioxide particles are obtained by the method described in EP-A-216 278 through the use of trialkoxysilanes which already carry the desired group for surface functionalisation. The modification of surfaces carrying hydroxyl groups is disclosed, for example, in EP-A-337 144. Further methods for the modification of particle surfaces are well known to the person skilled in the art, in particular from the production of chromatography materials, and are described in various textbooks, such as Unger, K. K., Porous Silica, Elsevier Scientific Publishing Company (1979).

The constituents containing electrophilic groups are preferably organometallic compounds of a (semi)metal from main group 3 or 4 of the Periodic Table, which are also referred to below as “cocatalyst”. They are particularly preferably a compound of the elements boron, aluminium, tin or silicon, preferably a compound of boron or aluminium. Halide-free compounds are preferred. The organic radicals of the compounds are preferably selected from the group consisting of alkyl, alkenyl, aryl, alkaryl, aralkyl, alkoxy, aryloxy, alkaryloxy and aralkoxy radicals and fluorine-substituted derivatives.

Preferred compounds are trialkylaluminium compounds, such as trimethylaluminium, triethylaluminium, tripropylaluminium and triisopropylaluminium.

Particular preference is also given to aluminoxanes containing alkyl groups on the aluminium, such as methyl-, ethyl-, propyl-, isobutyl-, phenyl- or benzylalumin-oxane, particular preference being given to methylaluminoxane, which is frequently known by the abbreviation MAO.

It is essential here that the constituent containing electrophilic groups is selected so that the microparticulate material forms through interaction with the nanoparticulate cores. The person skilled in the art is presented with absolutely no difficulties in selecting nucleophilic and electrophilic groups which interact with one another in a corresponding manner.

The microparticulate material is preferably built up from the nanoparticulate cores, with the cores being held together through interaction of the non-acidic, nucleophilic groups on the core with the electrophilic groups of the other constituents. A process for the production of a microparticulate material of this type in which nanoparticulate cores of inorganic material with oligomeric or polymeric structures containing non-acidic, nucleophilic groups on their surface are agglomerated with at least one further constituent containing electrophilic groups is likewise a subject-matter of the present invention.

In a particularly preferred embodiment of the present invention, the polymers containing non-acidic, nucleophilic groups are polyethylene oxide (PEO), and the further constituent containing electrophilic groups is methylaluminoxane (MAO). In this case, it is assumed that the agglomerates are formed and stabilised by coordination of the polymer chains of the PEO onto the metal cntres of the MAO. In accordance with this idea, the microparticulate material is a network of MAO with cores with PEO-modified surfaces.

The material according to the invention has the following advantages over the prior art on use as or in a catalyst:
The catalytically active compounds are homogeneously distributed on the support.
The catalyst fragments uniformly during the reaction.
The fragments formed are small and uniformly distributed in the reaction product.
Material properties of polymers prepared with the catalyst according to the invention are only influenced to a minimal extent, or not at all, by the small, homogeneously distributed catalyst fragments.
The homogeneous catalyst distribution on the support combined with the uniform fragmentation produces a uniform course of the catalysed reaction.
The catalyst can advantageously be employed in particular in reactions, such as polymerisation reactions, in which control of the heat of reaction represents a technical problem, since heat peaks are avoided through the uniform course of the reaction.

The above-mentioned advantages can be achieved in a particularly pronounced manner in polymerisation reactions. The catalyst according to the invention is therefore preferably a polymerisation catalyst or the use of the catalyst for polymerisation reactions is particularly preferred in accordance with the invention. In particular, it has been found, surprisingly, that the polymers obtained in this way have improved material properties compared with the prior art. In particular, advantages arise with regard to:
the transparency of the polymers
the tear strength of the polymers
the appearance of the polymers, since inhomogeneities due to catalyst fragments have been reduced.

In a preferred embodiment of the invention, spherical particles are obtained. Spherical here means that the particles give the impression of spheres in scanning electron photomicrographs. “Spherical” can be quantified in the sense that the means of the three mutually perpendicular diameters of the particles differ from one another by a maximum of 50% of the length. This means that all ratios of the three mutually perpendicular diameters are in each case in the range from 1.5:1 to 1:1.5. The ratios of the three mean diameters are preferably even all in the range from 1.3:1 to 1:1.3, i.e. the diameters differ from one another by a maximum of 30%.

The material according to the invention usually has mean particle sizes in the range from 1 to 150 μm, preferably in the range from 3 to 75 μm. The particle-size distribution here can be controlled by classification, for example by air classification. The surface area of the particles—determined by the BET method (S. Brunnauer, P. H. Emmett, E. Teller, J. Am. Chem. Soc. 1938, 60, 309)—is usually in the range from 50 to 500 m²/g, with surface areas in the range from 150 to 450 m²/g being preferred. The pore volume, likewise measured by the BET method, is typically in the range from 0.5 to 4.5 ml/g, with the pore volume preferably being greater than 0.8 ml/g and particularly preferably in the range from 1.5 to 4.0 ml/g.

The materials according to the invention are suitable as supports for a very wide variety of catalysts. In principle, all homogeneous catalysts can be immobilised with the aid of these materials.

In a particularly important embodiment of the present invention, the materials are employed as supports for catalysts for the polymerisation of olefins.

Conventional catalyst systems for the polymerisation of olefins consist of a compound of a transition metal from sub-groups 3 to 8 of the Periodic Table and a co-catalyst, usually an organometallic compound of a (semi)metal from main group 3 or 4 of the Periodic Table.

The present invention therefore furthermore relates to a heterogeneous catalyst which comprises at least one nanoparticulate material, as described above, at least one compound of a transition metal from sub-groups 3 to 8 of the Periodic Table, and at least one organometallic compound of a (semi)metal from main group 3 or 4 of the Periodic Table, where the transition-metal component and the organometallic component are bonded to the nanoparticulate material and together form the catalytically active species.

It is particularly preferred here for the nanoparticulate material and the transition-metal component or the organometallic component together to form a microparticulate material, as described above.

The compound of a transition metal from sub-groups 3 to 8 of the Periodic Table, which is also referred to below as “catalyst”, is preferably a complex compound, particularly preferably a metallocene compound. In principle, this can be any metallocene. Bridged (ansa-) and unbridged metallocene complexes with (substituted) π-ligands, such as cyclopentadienyl, indenyl or fluorenyl ligands, are conceivable here, giving symmetrical or asymmetrical complexes with central metals from groups 3 to 8. The central metals employed are preferably the elements titanium, zirconium, hafnium, vanadium, palladium, nickel, cobalt, iron or chromium, with titanium and in particular zirconium being particularly preferred.

Suitable zirconium compounds are, for example:
bis(cyclopentadienyl)zirconium monochloride monohydride,
bis(cyclopentadienyl)zirconium monobromide monohydride,
bis(cyclopentadienyl)methylzirconium hydride,
bis(cyclopentadienyl)ethylzirconium hydride,
bis(cyclopentadienyl)cyclohexylzirconium hydride,
bis(cyclopentadienyl)phenylzirconium hydride,
bis(cyclopentadienyl)benzylzirconium hydride,
bis(cyclopentadienyl)neopentylzirconium hydride,
bis(methylcyclopentadienyl)zirconium monochloride monohydride,
bis(indenyl)zirconium monochloride monohydride,
bis(cyclopentadienyl)zirconium dichloride,
bis(cyclopentadienyl)zirconium dibromide,
bis(cyclopentadienyl)methylzirconium monochloride,
bis(cyclopentadienyl)ethylzirconium monochloride,
bis(cyclopentadienyl)cyclohexylzirconium monochloride,
bis(cyclopentadienyl)phenylzirconium monochloride,
bis(cyclopentadienyl)benzylzirconium monochloride,
bis(methylcyclopentadienyl)zirconium dichloride,
bis(1,3-dimethylcyclopentadienyl)zirconium dichloride,
bis(n-butylcyclopentadienyl)zirconium dichloride,
bis(n-propylcyclopentadienyl)zirconium dichloride,
bis(isobutylcyclopentadienyl)zirconium dichloride,
bis(cyclopentylcyclopentadienyl)zirconium dichloride,
bis(octadecylcyclopentadienyl)zirconium dichloride,
bis(indenyl)zirconium dichloride,
bis(indenyl)zirconium dibromide,
bis(indenyl)dimethylzirconium,
bis(4,5,6,7-tetrahydro-1-indenyl)dimethylzirconium,
bis(cyclopentadienyl)diphenylzirconium,
bis(cyclopentadienyl)dibenzylzirconium,
bis(cyclopentadienyl)methoxyzirconium chloride,
bis(cyclopentadienyl)ethoxyzirconium chloride,
bis(cyclopentadienyl)butoxyzirconium chloride,
bis(cyclopentadienyl)-2-ethylhexoxyzirconium chloride,
bis(cyclopentadienyl)methylzirconium ethoxide,
bis(cyclopentadienyl)methylzirconium butoxide,
bis(cyclopentadienyl)ethylzirconium ethoxide,
bis(cyclopentadienyl)phenylzirconium ethoxide,
bis(cyclopentadienyl)benzylzirconium ethoxide,
bis(methylcyclopentadienyl)ethoxyzirconium chloride,
bis(indenyl)ethoxyzirconium chloride,
bis(cyclopentadienyl)ethoxyzirconium,
bis(cyclopentadienyl)butoxyzirconium,
bis(cyclopentadienyl)-2-ethylhexoxyzirconium,
bis(cyclopentadienyl)phenoxyzirconium monochloride,
bis(cyclopentadienyl)cyclohexoxyzirconium chloride,
bis(cyclopentadienyl)phenylmethoxyzirconium chloride,
bis(cyclopentadienyl)methylzirconium phenylmethoxide,
bis(cyclopentadiphenyl)trimethylsiloxyzirconium chloride,
bis(cyclopentadienyl)triphenylsiloxyzirconium chloride,
bis(cyclopentadienyl)thiophenylzirconium chloride,
bis(cyclopentadienyl)neoethylzirconium chloride,
bis(cyclopentadienyl)bis(dimethylamide)zirconium,
bis(cyclopentadienyl)diethylamidezirconium chloride,
dimethylsilylenebis(4,5,6,7-tetrahydro-1-indenyl)zirconium dichloride,
dimethylsilylenebis(4,5,6,7-tetrahydro-1-indenyl)dimethylzirconium,
dimethylsilylenebis(2-methyl-4,5-benzoindenyl)zirconium dichloride,
dimethylsilylenebis(4-tert-butyl-2-methylcyclopentadienyl)zirconium dichloride,
dimethylenesilylbis(4-tert-butyl-2-methylcyclopentadienyl)dimethylzirconium,
ethylenebis(indenyl)ethoxyzirconium chloride,
ethylenebis(4,5,6,7-tetrahydro-1-indenyl)ethoxyzirconium chloride,
ethylenebis(indenyl)dimethylzirconium,
ethylenebis(indenyl)diethylzirconium,
ethylenebis(indenyl)diphenylzirconium,
ethylenebis(indenyl)dibenzylzirconium,
ethylenebis(indenyl)methylzirconium monobromide,
ethylenebis(indenyl)ethylzirconium monochloride,
ethylenebis(indenyl)benzylzirconium monochloride,
ethylenebis(indenyl)methylzirconium monochloride,
ethylenebis(indenyl)zirconium dichloride,
ethylenebis(indenyl)zirconium dibromide,
ethylenebis(4,5,6,7-tetrahydro-1-indenyl)dimethylzirconium,
ethylenebis(4,5,6,7-tetrahydro-1-indenyl)methylzirconium monochloride,
ethylenebis(4,5,6,7-tetrahydro-1-indenyl)zirconium dichloride,
ethylenebis(4,5,6,7-tetrahydro-1-indenyl)zirconium dibromide,
ethylenebis(4-methyl-1-indenyl)zirconium dichloride,
ethylenebis(5-methyl-1-indenyl)zirconium dichloride,
ethylenebis(6-methyl-1-indenyl)zirconium dichloride,
ethylenebis(7-methyl-1-indenyl)zirconium dichloride,
ethylenebis(5-methoxy-1-indenyl)zirconium dichloride,
ethylenebis(2,3-dimethyl-1-indenyl)zirconium dichloride,
ethylenebis(4,7-dimethyl-1-indenyl)zirconium dichloride,
ethylenebis(4,7-dimethoxy-1-indenyl)zirconium dichloride,
ethylenebis(indenyl)zirconium dimethoxide,
ethylenebis(indenyl)zirconium diethoxide,
ethylenebis(indenyl)methoxyzirconium chloride,
ethylenebis(indenyl)ethoxyzirconium chloride,
ethylenebis(indenyl)methylzirconium ethoxide,
ethylenebis(4,5,6,7-tetrahydro-1-indenyl)zirconium dimethoxide,
ethylenebis(4,5,6,7-tetrahydro-1-indenyl)zirconium diethoxide,
ethylenebis(4,5,6,7-tetrahydro-1-indenyl)methoxyzirconium chloride,
ethylenebis(4,5,6,7-tetrahydro-1-indenyl)ethoxyzirconium chloride,
ethylenebis(4,5,6,7-tetrahydro-1-indenyl)methylzirconium ethoxide,
ethylenebis(4,5,6,7-tetrahydro-1-indenyl)dimethylzirconium,
isopropylene(cyclopentadienyl)(1-fluorenyl)zirconium dichloride,
diphenylmethylene(cyclopentadienyl)(1-fluorenyl)zirconium dichloride.

Suitable titanium compounds are, for example:
bis(cyclopentadienyl)titanium monochloride monohydride,
bis(cyclopentadienyl)methyltitanium hydride,
bis(cyclopentadienyl)phenyltitanium chloride,
bis(cyclopentadienyl)benzyltitanium chloride,
bis(cyclopentadienyl)titanium dichloride,
bis(cyclopentadienyl)dibenzyltitanium,
bis(cyclopentadienyl)ethoxytitanium chloride,
bis(cyclopentadienyl)butoxytitanium chloride,
bis(cyclopentadienyl)methyltitanium ethoxide,
bis(cyclopentadienyl)phenoxytitanium chloride,
bis(cyclopentadienyl)trimethylsiloxytitanium chloride,
bis(cyclopentadienyl)thiophenyltitanium chloride,
bis(cyclopentadienyl)bis(dimethylamide)titanium,
bis(cyclopentadienyl)ethoxytitanium,
bis(n-butylcyclopentadienyl)titanium dichloride,
bis(cyclopentylcyclopentadienyl)titanium dichloride,
bis(indenyl)titanium dichloride,
ethylenebis(indenyl)titanium dichloride,
ethylenebis(4,5,6,7-tetrahydro-1-indenyl)titanium dichloride and
dimethylsilylene(tetramethylcyclopentadienyl)(tert-butylamido)titanium dichloride.

Suitable hafnium compounds are, for example:
bis(cyclopentadienyl)hafnium monochloride monohydride,
bis(cyclopentadienyl)ethylhafnium hydride,
bis(cyclopentadienyl)phenylhafnium chloride,
bis(cyclopentadienyl)hafnium dichloride,
bis(cyclopentadienyl)benzylhafnium,
bis(cyclopentadienyl)ethoxyhafnium chloride,
bis(cyclopentadienyl)butoxyhafnium chloride,
bis(cyclopentadienyl)methylhafnium ethoxide,
bis(cyclopentadienyl)phenoxyhafnium chloride,
bis(cyclopentadienyl)thiophenylhafnium chloride,
bis(cyclopentadienyl)bis(diethylamide)hafnium,
ethylenebis(indenyl)hafnium dichloride,
ethylenebis(4,5,6,7-tetrahydro-1-indenyl)hafnium dichloride and
dimethylsilylenebis(4,5,6,7-tetrahydro-1-indenyl)hafnium dichloride.

Suitable iron compounds are, for example:
2,6-[1-(2,6-diisopropylphenylimino)ethyl]pyridineiron dichloride,
2,6-[1-(2,6-dimethylphenylimino)ethyl]pyridineiron dichloride.

Suitable nickel compounds are, for example:
(2,3-bis(2,6-diisopropylphenylimino)butane)nickel dibromide,
1,4-bis(2,6-diisopropylphenyl)acenaphthenediiminonickel dichloride,
1,4-bis(2,6-diisopropylphenyl)acenaphthenediiminonickel dibromide.

Suitable palladium compounds are, for example:
(2,3-bis(2,6-diisopropylphenylimino)butane)palladium dichloride and
(2,3-bis(2,6-diisopropylphenylimino)butane)dimethylpalladium.

Particular preference is given here to the use of zirconium compounds, with the compounds bis(cyclopentadienyl)zirconium dichloride, bis(n-butylcyclopenta-dienyl)zirconium dichloride, ethylenebis(4,5,6,7-tetrahydro-1-indenyl)zirconium dichloride, bis(methylcyclopentadienyl)zirconium dichloride and bis(1,3-dimethyl-cyclopentad ienyl)zirconium dichloride being particularly preferred.

However, the compound of a transition metal from sub-groups 3 to 8 can, in accordance with the invention, also be a classical Ziegler-Natta compound, such as titanium tetrachloride, tetraalkoxytitanium, alkoxytitanium chlorides, vanadium halides, vanadium oxide halides and alkoxyvanadium compounds in which the alkyl radicals have from 1 to 20 carbon atoms.

In accordance with the invention, it is possible to employ both pure transition-metal compounds and mixtures of various transition-metal compounds, where both mixtures of metallocenes or Ziegler-Natta compounds with one another and also mixtures of metallocenes with Ziegler-Natta compounds may be advantageous.

The mean particle size of the catalyst particles is usually in the range from 1 to 150 μm, preferably in the range from 3 to 75 μm.

In a preferred embodiment of the invention, the heterogeneous catalyst according to the invention enables the production of polymer particles having a controllable particle size and shape. The particle size here can be set in the range from about 50 μm to about 3 mm. A preferred particle shape is the spherical shape, which, as described above, can be produced by spherical support particles having a particularly uniform catalyst coating.

The present invention furthermore relates to a process for the preparation of the heterogeneous catalyst according to the invention in which
a) at least one nanoparticulate material, as described above, is reacted with at least one organometallic compound of a (semi)metal from main group 3 or 4 of the Periodic Table, and
b) with at least one compound of a transition metal from sub-groups 3 to 8 of the Periodic Table to give the heterogeneous catalyst.

The preparation of the heterogeneous catalyst using the nanoparticulate material according to the invention can be carried out by various processes, taking particular account of the sequence of the reaction of the components with one another:

In a preferred process, the organometallic compound of a (semi)metal from main group 3 or 4 of the Periodic Table (referred to below as cocatalyst) is firstly absorbed on the nanoparticulate material (also referred to below as support), and the compound of a transition metal from sub-groups 3 to 8 of the Periodic Table (also referred to below as catalyst) is subsequently added. In another, likewise preferred process, a mixture of catalyst and cocatalyst is reacted with the support. In certain cases, it may also be preferred for the catalyst firstly to be immobilised on the support and subsequently reacted with the cocatalyst. In a preferred variant of the process, a microparticulate material according to the invention is formed from the nanoparticulate material by reaction with the first component of cocatalyst or catalyst. Alternatively, for example, the cocatalyst methylaluminoxane can also be formed in situ by reaction of trimethylaluminium with a water-containing support material. Direct chemical bonding of the metallocene catalyst to the nanoparticulate material with the aid of a spacer or anchor group is also a possible step in the preparation of the heterogeneous catalyst.

The nanoparticulate material is usually suspended in an inert solvent, and the catalyst and cocatalyst are added as a solution or suspension. After the individual reaction steps, washing with a suitable solvent can be carried out for purification.

All process steps of the catalyst preparation are preferably carried out under a protective gas, for example argon or nitrogen.

Suitable inert solvents are, for example, pentane, isopentane, hexane, heptane, octane, nonane, cyclopentane, cyclohexane, benzene, toluene, xylene, ethylbenzene and diethylbenzene.

In a particularly preferred variant of the process according to the invention, the nanoparticulate material is reacted with an aluminoxane, preferably commercially available methylaluminoxane. In this case, the nanoparticulate material is suspended, for example in toluene, and subsequently reacted with the aluminium component for about 30 minutes at temperatures between 0 and 140° C. This gives a heterogenised methylaluminoxane as microparticulate material. The cocatalyst supported in this way is subsequently brought into contact with a metallocene, preferably dicyclopentadienylzirconium dichloride, with the catalyst/cocatalyst ratio being between 1 and 1:100,000. The mixing time is from 5 minutes to 48 hours, preferably from 5 to 60 minutes.

The actual catalytically active centres of the heterogeneous catalyst according to the invention do not form until during the reaction of the nanoparticulate material with the catalyst and cocatalyst components.

In accordance with the invention, the heterogeneous catalysts are preferably employed for the preparation of polyolefins.

The present invention accordingly also relates to the use of a heterogeneous catalyst as described above for the preparation of polyolefins.

The term “polyolefins” here is very generally taken to mean macromolecular compounds which can be obtained by polymerisation of substituted or unsubstituted hydrocarbon compounds having at least one double bond in the monomer molecule.

Olefin monomers here preferably have a structure of the formula R¹ CH═CHR², where R¹ and R² may be identical or different and are selected from the group consisting of hydrogen and the cyclic and acyclic alkyl, aryl and alkylaryl radicals having from 1 to 20 carbon atoms.

Olefins which can be employed are monoolefins, such as, for example, ethylene, propylene, but-1-ene, pent-1-ene, hex-1-ene, oct-1-ene, hexadec-1-ene, octadec-1-ene, 3-methylbut-1-ene, 4-methylpent-1-ene and 4-methylhex-1-ene, diolefins, such as, for example, 1,3-butadiene, 1,4-hexadiene, 1,5-hexadiene, 1,6-hexadiene, 1,6-octadiene and 1,4-dodecadiene, aromatic olefins, such as styrene, o-methylstyrene, m-methylstyrene, p-methylstyrene, p-tert-butylstyrene, m-chlorostyrene, p-chlorostyrene, indene, vinylanthracene, vinylpyrene, 4-vinylbiphenyl, dimethanooctahydronaphthalene, acenaphthalene, vinylfluorene and vinyl-chrysene, cyclic olefins and diolefins, such as, for example, cyclopentene, 3-vinyl-cyclohexene, dicyclopentadiene, norbornene, 5-vinyl-2-norbornene, tert-ethylidene-2-norbornene, 7-octenyl-9-borabicyclo[3.3.1]nonane, 4-vinylbenzo-cyclobutane and tetracyclododecene, and furthermore, for example, acrylic acid, methacrylic acid, methyl methacrylate, ethyl acrylate, acrylonitrile, 2-ethylhexyl acrylate, methacrylonitrile, maleimide, N-phenylmaleimide, vinylsilane, trimethyl-allylsilane, vinyl chloride, vinylidene chloride and isobutylene.

Particular preference is given to the olefins ethylene, propylene and generally further 1-olefins, which are either homopolymerised or alternatively copolymerised in mixtures with other monomers. The present invention accordingly furthermore relates to a process for the preparation of polyolefins in which use is made of a heterogeneous catalyst as described above and an olefin of the formula R¹CH═CHR², where R¹ and R² may be identical or different and are selected from the group consisting of hydrogen and the cyclic and acyclic alkyl, aryl and alkylaryl radicals having from 1 to 20 carbon atoms.

The polymerisation is carried out in a known manner by solution, suspension or gas-phase polymerisation, continuously or discontinuously, with gas-phase and suspension polymerisation expressly being preferred. Typical temperatures in the polymerisation are in the range from 0° C. to 200° C., preferably in the range from 20° C. to 140° C.

The polymerisation is preferably carried out in pressure autoclaves. If necessary, hydrogen may be added as molecular-weight regulator during the polymerisation.

The heterogeneous catalysts used in accordance with the invention enable the preparation of homopolymers, copolymers and block copolymers.

As described above, virtually spherical polymer particles having a controllable particle size can be obtained through suitable choice of support.

The invention therefore also relates to the use of a heterogeneous catalyst according to the invention or of a heterogeneous catalyst prepared in accordance with the invention for the preparation of polyolefins having a spherical particle structure.

### EXAMPLES

The following abbreviations are used below:
MAO methylaluminoxane
PEO polyethylene oxide
Monospher® xxx monodisperse silicon dioxide particles having a mean particle diameter of xxx nm, standard deviation of the mean particle diameters<5% (Merck KGaA, Darmstadt)

### Example 1

### Preparation of the Catalyst

a) Functionalisation of the Nanoparticles (Monospheres® 100 (Merck))

60 g of Monospheres® 100 (Merck, average diameter of the spherical SiO₂ particles: 100 nm, standard deviation of the mean particle size<5%) (corresponding to 60 g=1 mol of SiO₂) in the form of a 10% by weight ethanolic solution are mixed with 4.93 g (20 mmol) of 2-(3,4-epoxycyclohexyl)ethylmethoxysilane at 70° C. with vigorous stirring. The dispersion is refluxed for 24 hours. The dispersion is subsequently evaporated to dryness, and the powder is dried overnight at 70° C under reduced pressure, giving a surface coverage density of 10 μmol/m².

b) Grafting-on of the Polyethylene Oxide Chains

5.25 g of polyethylene oxide 350 (M=350 g/mol) are stirred in 50 ml of tetrahydrofuran together with 100 mg of sodium until the evolution of gas ceases. The solution is added using a syringe to a suspension of 5 g of Monospher® 100 treated in accordance with Example 1a) in tetrahydrofuran. After stirring for one hour, 2 ml of water are added, the Monospher is purified by centrifugation and washing with tetrahydrofuran three times, and subsequently dried.

c) Metallocene Immobilisation

1 g of the PEO-functionalised Monospher from Example 1b) is suspended in 20 ml of a solution of methylaluminoxane (MAO) in toluene (c(Al)=1.5 mol/l). After stirring for one hour, 3 ml of a solution of 0.31 mmol of dicyclopentadienylzirconium dichloride in 11 ml of MAO solution in toluene (c(Al)=1.5 mol/l) are added, the mixture is stirred for 30 minutes, and the solvent is removed under reduced pressure.

The resultant catalyst has a coverage of 0.028 mmol of metallocene/g of catalyst (total weight incl. metallocene and cocatalyst) and an Al/Zr ratio of 410. Scanning electron photomicrographs show particle-sizes for the catalyst particles of about 50 μm.

### Example 2

### Preparation of the Catalyst

a) Functionalisation of the Nanoparticles (Monospheres® 150 (Merck))

16.1 g of Monospheres® 150 (Merck, average diameter of the spherical SiO₂ particles: 150 nm, standard deviation of the mean particle size<5%) are suspended in 300 ml of water, and a solution of 2.44 g (12.34 mmol) of trimethoxychloropropylsilane in 25 ml of ethanol is slowly added dropwise under reflux. The dispersion is refluxed for 24 hours. The functionalised Monospheres are subsequently separated off by centrifugation. Purification is carried out by suspending in ethanol three times followed by centrifugation. The resultant powder is dried under reduced pressure.

b) Grafting-On of the Polyethylene Oxide Chains

2.68 g of polyethylene oxide 350 (M=350 g/mol) are slowly added at 0° C. to 221 mg of sodium hydride in 50 ml of tetrahydrofuran. The mixture is subsequently stirred for a further 30 minutes at 0° C. and for a further 30 minutes at 30 room temperature. The solution is added using a syringe to a suspension of 5 g of the chloropropoxy-functionalised Monospher® 150 (from Example 2a) in tetrahydrofuran. After stirring for 12 hours, the solvent is removed, and the residue is washed three times with ethanol.

c) Metallocene Immobilisation

1 g of the PEO-functionalised Monospher from Example 2b) is suspended in 20 ml of a solution of methylaluminoxane (MAO) in toluene (c(Al)=1.5 mol/l). After stirring for one hour, 3 ml of a solution of 0.31 mmol of dicyclopentadienylzirconium dichloride in 11 ml of MAO solution in toluene (c(Al)=1.5 mol/l) are added, the mixture is stirred for 30 minutes, and the solvent is removed under reduced pressure.

### Example 3

### Polymerisation

5 ml of a solution of triisobutylaluminium in hexane (c(Al)=1 mol/l) were introduced into a 1 l steel autoclave. The autoclave was filled with 400 ml of isobutane and heated to 70° C., and ethene was introduced to a pressure of 36 bar. 70 mg of the catalyst from Example 1 were introduced via a pressure lock by means of an excess pressure of argon. The reactor pressure was kept constant at 40 bar during the polymerisation by means of ethene via a Pressflow controller.

After a polymerisation time of 1 hour, the reaction is terminated by releasing the pressure. The isobutane evaporates in the process, and the polyethene remains as free-flowing granules.

Yield: 48.6 g, productivity: 700 g of PE/g of cat.

1. Microparticulate material comprising nanoparticulate cores of inorganic material with oligomeric or polymeric structures containing non-acidic, nucleophilic groups on their surface, where the cores have been agglomerated via interaction of the non-acidic, nucleophilic groups with at least one further constituent containing electrophilic groups.

2. Microparticulate material according to claim 1 for use as a catalyst, formed from a support, at least one catalytically active species and optionally at least one cocatalyst, characterised in that the support comprises the cores of inorganic material.

3. Microparticulate material according to claim 1, characterised in that the further constituents containing electrophilic groups are at least one catalytically active species or at least one cocatalyst.

4. Nanoparticulate material comprising cores of inorganic material, where oligomeric or polymeric structures containing non-acidic, nucleophilic groups are present on the surface of the cores.

5. Microparticulate material according to claim 1 or nanoparticulate material according to the invention, characterised in that the inorganic material of the cores is an oxidic material which is preferably selected from the oxides of the elements from main groups 3 and 4 and sub-groups 3 to 8 of the Periodic Table, particularly preferably an aluminium oxide, silicon oxide, boron oxide, germanium oxide, titanium oxide, zirconium oxide or iron oxide, or a mixed oxide or an oxide mixture of the said compounds.

6. Microparticulate material according to claim 1 or nanoparticulate material according to the invention, characterised in that the oligomeric or polymeric structures containing non-acidic, nucleophilic groups on the surface of the cores are polymers, preferably linear polymers, which have been grafted onto the surface, where the non-acidic, nucleophilic groups may either be present directly in the main chain of the polymers or can be in the form of functional groups or small molecules as a side chain.

7. Microparticulate material or nanoparticulate material according to claim 6, characterised in that the polymer containing non-acidic, nucleophilic groups is a polyether, such as, in particular, polyethylene oxide, polypropylene oxide or a mixed polymer of ethylene oxide and propylene oxide, or polyvinyl alcohol, a polysaccharide or a polycyclodextrin.

8. Microparticulate material or nanoparticulate material according to claim 1, characterised in that the surface of the cores has been functionalised with chemical functions which, as active chain end, enable the shell polymers to be grafted on, preferably with terminal double bonds, halogen functions, epoxy groups or polycondensable groups.

9. Microparticulate material according to claim 1, characterised in that the constituents containing electrophilic groups are organometallic compounds of a (semi)metal from main group 3 or 4 of the Periodic Table, preferably a compound of the elements boron, aluminium, tin or silicon, particularly preferably methylaluminoxane.

10. Microparticulate material according to claim 1, characterised in that the polymers containing non-acidic, nucleophilic groups are polyethylene oxide (PEO), and the further constituent containing electrophilic groups is methylaluminoxane (MAO).

11. Microparticulate material according to claim 1, characterised in that it consists of spherical particles in which all ratios of the means of the three mutually perpendicular diameters are in each case in the range from 1.5:1 to 1:1.5, and the mean particle size of the material is in the range from 1 to 150 μm, preferably in the range from 3 to 75 μm.

12. Heterogeneous catalyst comprising
a) at least one nanoparticulate material according to claim 4,
b) at least one compound of a transition metal from sub-groups 3 to 8 of the Periodic Table, and
c) at least one organometallic compound of a (semi)metal from main group 3 or 4 of the Periodic Table,
where components b) and c) are bonded to the nanoparticulate material a) and together form the catalytically active species.

13. Heterogeneous catalyst according to claim 12, characterised in that constituent a) and constituent b) or c) together form a microparticulate material according to the invention.

14. Heterogeneous catalyst according to claim 1, characterised in that the compound of a transition metal from sub-groups 3 to 8 of the Periodic Table is a complex compound, particularly preferably a metallocene compound, where the central metal is preferably selected from the elements titanium, zirconium, hafnium, vanadium, palladium, nickel, cobalt, iron and chromium, with particularly preferred central atoms being titanium and in particular zirconium.

15. Process for the production of a nanoparticulate material, characterised in that oligomeric or polymeric structures containing non-acidic, nucleophilic groups are applied to the surface of cores of inorganic material.

16. Process according to claim 15, characterised in that the surface of the cores is functionalised before application of the oligomeric or polymeric structures.

17. Process for the production of a microparticulate material, characterised in that nanoparticulate cores of inorganic material with oligomeric or polymeric structures containing non-acidic, nucleophilic groups on their surface are agglomerated with at least one further constituent containing electrophilic groups.

18. Process for the preparation of a heterogeneous catalyst, characterised in that
a) at least one nanoparticulate material according to claim 4 or a material produced according to the invention is reacted with at least one organometallic compound of a (semi)metal from main group 3 or 4 of the Periodic Table, and
b) with at least one compound of a transition metal from sub-groups 3 to 8 of the Periodic Table to give the heterogeneous catalyst.

19. Use of a heterogeneous catalyst according to claim 12 or of a heterogeneous catalyst prepared by a process according to the invention for the preparation of polyolefins.

20. Process for the preparation of polyolefins, characterised in that use is made of a heterogeneous catalyst according to claim 12 or a heterogeneous catalyst prepared by a process according to the invention and an olefin of the formula R¹CH═CHR², where R¹ and R² may be identical or different and are selected from the group consisting of hydrogen and the cyclic and acyclic alkyl radicals having from 1 to 20 carbon atoms.

21. Process for the preparation of polyolefins according to claim 20, characterised in that the polymerisation is carried out as a gas-phase or suspension polymerisation.

22. Use of a heterogeneous catalyst according to claim 12 or of a heterogeneous catalyst prepared by a process according to the invention for the preparation of polyolefins having a spherical particle structure.
